(19) United States
(12) Patent Application Publication
(10) Pub. No.: US 2008/0290251 A1
(43) Pub. Date: Nov. 27, 2008

(54) Led Lighting System and Control Method

(75) Inventors: Peter Hubertus Franciscus Deurenberg, Eindhoven (NL); Christoph Gerard August Hoelen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,621

(22) PCT Filed: Nov. 13, 2006
(86) PCT No.: PCT/IB06/54224

§ 371 Date: May 22, 2008

(30) Foreign Application Priority Data
Nov. 22, 2005 (EP) 05111067.4

(51) Int. Cl. G01J 1/20

(52) U.S. Cl. 250/201.1

(57) ABSTRACT

The present invention relates to a light emitting diode (LED) lighting system (10) comprising a plurality of LED light sources for generating a mixed color light, the plurality of LED light sources including at least one LED light source comprising at least one LED adapted to emit light of a first wavelength and a wavelength converter for converting at least a portion of the light emitted from the LED(s) to light of another wavelength, and a control system (33) for individually controlling the flux output of the LED light sources. The control system in turn comprises means for providing feedback of the flux of at least one of the LED light sources, the feedback being based on input from an unfiltered sensor (22) responsive to the actual flux of the individual LED light source, for allowing control of the at least one LED light source in accordance with the feedback, and means for providing first control data based on input from a filtered sensor (36) responsive to the first wavelength flux, for allowing adjustment of at least one LED light source, to compensate for first wavelength leakage of the wavelength converted LED light source(s). The present invention also relates to a system and method for controlling a LED lighting unit.

The present invention relates to a light emitting diode (LED) lighting system comprising a plurality of LED light sources for generating a mixed color light, the plurality of LED light sources including at least one LED light source comprising at least one LED adapted to emit light of a first wavelength and a wavelength converter for converting at least a portion of the light emitted from the LED(s) to light of another wavelength. The invention also relates to a control system and method for a LED lighting unit.

Mixing multiple colored LEDs to obtain a mixed color is a common way to generate white or colored light. The generated light is determined by a number of factors, for instance, the type of LEDs used, the color ratios, the driving ratios, the mixing ratios, etc. However, the optical characteristics of the LEDs change when the LEDs rise in temperature during operation: the flux output decreases and the peak wavelength shifts.

To overcome or alleviate this problem, various color control systems have been proposed in order to compensate for these changes in optical characteristics of the LEDs during use. Examples of color control systems or algorithms include color coordinates feedback (CCFB), temperature feed forward (TFF), flux feedback (FFB), or a combination of the last two (FBB+TFF), as disclosed in for example in the publication “Achieving color point stability in RGB multi-chip LED modules using various color control loops”, P. Deurenberg et al., Proc. SPIE Vol. 5941, 59410C (Sep. 7, 2005).

It has also been proposed to use various so called phosphor converted LEDs for producing a mixed color light, which LEDs are more stable in light output compared to a traditional intrinsic LED. In a phosphor converted LED, a portion of the light from an underlying LED is converted by a color converter (e.g. phosphor) into light of another wavelength.

However, phosphor converted LEDs tend to leak a portion of the (unconverted) light from the underlying LED. This leakage mixes with the converted light and changes the apparent color emitted from the phosphor converted LED. Further, this leakage changes over time and temperature (due to for example the temperature sensitivity of the underlying LED), resulting in a change in output (for example the unconverted light from the underlying LED increases and the converted light decreases). The change is especially significant if the wavelength of the light from the underlying LED is in the visible spectrum. This change cannot in a satisfying manner be compensated by the above mentioned color control systems, since they cannot discern the leakage of unconverted light from the underlying LED from the total output of the phosphor converted LEDs.

It is an object of the present invention to overcome this problem, and to provide an improved, more stable LED lighting system.

These and other objects that will be evident from the following description are achieved by means of a LED lighting system, and a method for controlling a LED lighting unit, according to the appended claims.

According to an aspect of the invention, there is provided an LED lighting system comprising a plurality of LED light sources for generating a mixed color light, the plurality of LED light sources including at least one LED light source comprising at least one LED adapted to emit light of a first wavelength and a wavelength converter for converting at least a portion of the light emitted from the LED(s) to light of another wavelength, and a control system for individually controlling the flux output of the LED light sources, the control system comprising: means for providing feedback of the flux of at least one of said LED light sources, the feedback being based on input from an unfiltered sensor responsive to the actual flux of the individual LED light source, for allowing control of the at least one LED light source in accordance with the feedback, and means for providing first control data based on input from a filtered sensor responsive to the first wavelength flux, for allowing adjustment of at least one LED light source, to compensate for first wavelength leakage of the wavelength converted LED light source(s).

By means of the filtered sensor, it is possible to discern the leakage of light having the first wavelength and make a corresponding compensation of at least one of the LED light sources. This results in a more stable lighting system with respect to color and flux.

The above feedback means and unfiltered sensor implements flux feedback (FFB) functionality in the system. Preferably, the feedback (total actual flux per LED light source) is compared, for at least one LED light source, to setpoint values representing a desired flux for the LED light source, whereby the LED light sources in question each can be controlled in accordance with the difference between the feedback and the setpoint value. The total actual flux can be obtained by time multiplexing the unfiltered sensor by means of a time multiplexor over the LED light sources for which actual flux is to be obtained. Preferably, the unfiltered sensor has lower sensitivity for the first wavelength and higher sensitivity for other wavelengths, in order to minimize the effect of the first wavelength leakage when the sensor measures a wavelength converted LED light source.

In one embodiment, the plurality of LED light sources further includes at least one intrinsic LED light source having a wavelength in the same wavelength range as the first wavelength, the first control data represents total actual first wavelength flux of all LED light sources, and the control system is adapted to control the intrinsic LED light source in accordance with a difference between a setpoint value representing a desired flux for the intrinsic LED light source and the first control data. In this way, the total actual first wavelength flux (the leakage from the wavelength converted LED light sources and the emission from the intrinsic LED light source emitting at the first wavelength) can be compensated by adjusting the one intrinsic LED light source emitting at the first wavelength.

In another embodiment, the means for providing first control data comprises a time multiplexor for time multiplexing the filtered sensor over the wavelength converted LED light source(s), the first control data represents actual first wavelength flux of each wavelength converted LED light source, and the control system is adapted to compensate setpoint values representing a desired flux for the wavelength converted LED light source(s) in accordance with the first control data. Thus, the portion of the flux that relates to the first wavelength is derived for each wavelength converted LED light source, which information is used to compensate the setpoint values for the wavelength converted LED light source in order to account for changes in first wavelength leakage.

In yet another embodiment, instead of compensating the setpoint values for the wavelength converted LED light source(s), the control system is adapted to adjust the feedback for the wavelength converted LEDs in accordance with the first control data representing actual first wavelength flux of each wavelength converted LED light source. This is an alternative way to account for changes in first wavelength leakage, and it also results in a more stable lighting system.

Additionally, for the compensation or adjustment based on first control data representing actual first wavelength flux of each wavelength converted LED light source, this actual first wavelength flux can be calculated based on input from both the filtered sensor and the unfiltered sensor. Also, in a case where the LED lighting unit of these embodiments includes an intrinsic LED light source having a wavelength in the same wavelength range as the first wavelength, this light source could be controlled based on feedback from the unfiltered sensor, as the other LED light sources. However, preferably, the intrinsic LED light source is controlled based on feedback from the filtered sensor (by time multiplexing the filtered sensor over the intrinsic LED light source), since this minimizes the number of measurements of the sensors.

Preferably, the above mentioned sensors are photodiodes. Also preferably, the first wavelength corresponds to blue color, whereby the above mentioned matched intrinsic LED light source is a blue LED light source, and the filtered photodiode can be a blue photodiode. Further, the wavelength converter preferably comprises phosphor, which together with for example underlying blue LEDs can be used to generate for instance white light.

The above compensation or adjustment with respect to first wavelength leakage combined with FFB can additionally be combined with temperature feed forward (TFF) functionality, whereby the system further comprises means for deriving the temperature of each LED light source and means for compensating the setpoint values representing desired flux for the LED light sources in accordance with second control data including the LED light source temperatures, in order to compensate for the peak wavelength shift of the LED light sources as the LED light source temperature change.

In order to derive the temperature of each LED light source, the derive means can comprises a temperature sensor adapted to measure the temperature of a heat sink accommodating the LED light sources, and means for calculating the LED light source temperatures based on at least the measured heat sink temperature and a thermal model of the plurality of LED light sources.

According to another aspect of the invention, there is provided a control system for a LED lighting unit, which LED lighting unit comprises a plurality of LED light sources for generating a mixed color light, the plurality of LED light sources including at least one LED light source comprising at least one LED adapted to emit light of a first wavelength and a wavelength converter for converting at least a portion of the light emitted from the LED(s) to light of another wavelength, wherein the control system is adapted to individually control the flux output of the LED light sources and comprises means for providing feedback of the flux of at least one of the LED light sources, the feedback being based on input from an unfiltered sensor responsive to the actual flux of the individual LED light source, for allowing control of the at least one LED light source in accordance with the feedback, and means for providing first control data based on input from a filtered sensor responsive to the first wavelength flux, for allowing adjustment of at least one LED light source, to compensate for first wavelength leakage of the wavelength converted LED light source(s). This control system offers similar advantages as obtained with the previously discussed aspect of the invention.

According to yet another aspect of the invention, there is provided a method for controlling a LED lighting unit including a plurality of LED light sources for generating a mixed color light, the plurality of LED light sources including at least one LED light source comprising at least one LED adapted to emit light of a first wavelength and a wavelength converter for converting at least a portion of the light emitted from the LED(s) to light of another wavelength, the method comprising providing feedback of the flux of at least one of the LED light sources, the feedback being based on input from an unfiltered sensor responsive to the actual flux of the individual LED light source, controlling the at least one LED light source in accordance with the feedback, providing first control data based on input from a filtered sensor responsive to the first wavelength flux, and adjusting the flux of at least one LED light source in accordance with the first control data, to compensate for first wavelength leakage of the wavelength converted LED light source(s). This method offers similar advantages as obtained with the previously discussed aspects of the invention.

These and other aspects of the present invention will now be described in more detail, with reference to the appended drawings showing currently preferred embodiments of the invention.

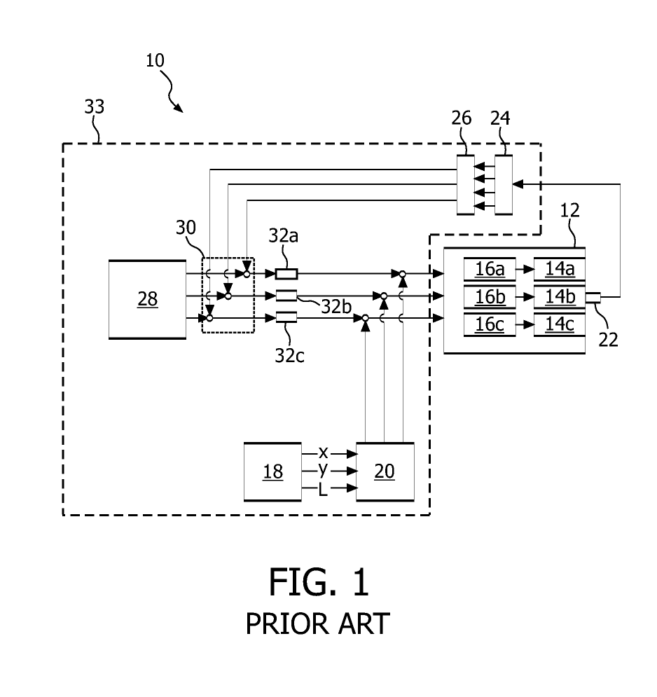

FIG. 1 is a block diagram of a LED lighting system with FFB functionality according to prior art,

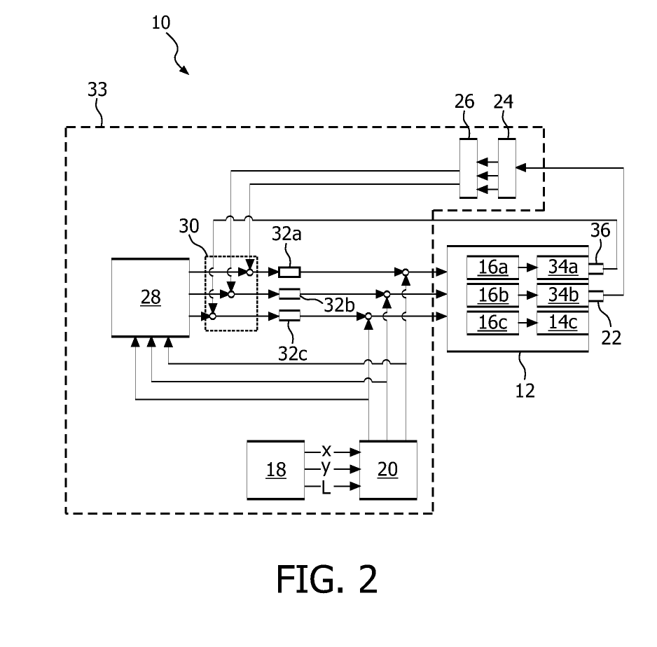

FIG. 2 is a block diagram of a LED lighting system according to an embodiment of the present invention,

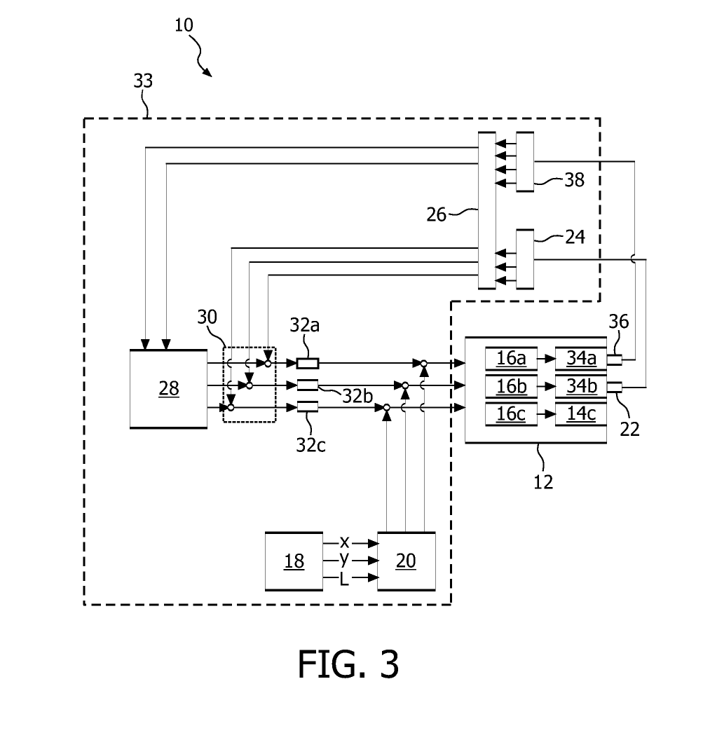

FIG. 3 is a block diagram of a LED lighting system according to another embodiment of the present invention, and

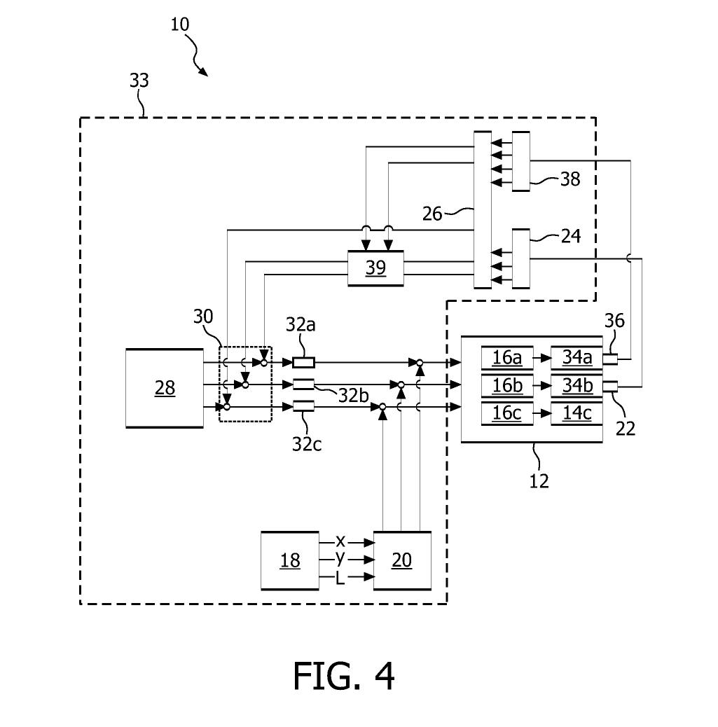

FIG. 4 is a block diagram of a LED lighting system according to yet another embodiment of the present invention, and

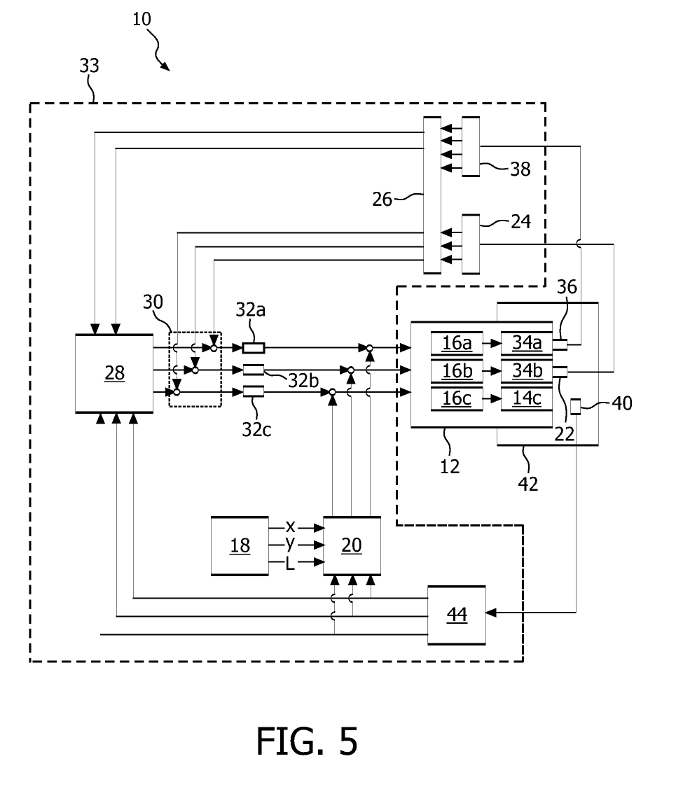

FIG. 5 is a block diagram of a variant of the LED lighting system of FIG. 3 with additional TFF functionality.

FIG. 1 is a block diagram of a prior art LED lighting system 10. A LED lighting system of this type is disclosed in for example the above mentioned publication “Achieving color point stability in RGB multi-chip LED modules using various color control loops”, P. Deurenberg et al., Proc. SPIE Vol. 5941, 59410C (Sep. 7, 2005).

The LED lighting system 10 comprises a LED lighting unit 12, which in turn comprises one LED light source 14a including LEDs adapted to emit red light, one LED light source 14b including LEDs adapted to emit green light, and one LED light source 14c including LEDs adapted to emit blue light. The LEDs are all “regular” intrinsic LEDs adapted to directly emit (visible) radiation. Each LED light source 14 is connected to a corresponding driver 16 for driving the LED light source. The LED lighting system 10 can for instance produce white light by mixing the output of the different LED light sources 14, and it can be used for illumination or lighting purposes. Also, the LED lighting system 10 can be a variable color LED lighting system.

The LED lighting system 10 further comprises a user interface 18 and a calibration matrix 20. A user input indicating a desired output of the LED lighting unit 12 is received through the user interface 18. The user input can for example be specified in CIE x, y, L representing a certain position in the CIE 1931 chromaticity diagram. The user input is transferred to the calibration matrix 20, which calculates nominal duty cycles for each color R, G, B based on the user input (i.e. the user input in converted from the user domain to the actuator domain).

In order to implement flux feedback functionality, the LED lighting system 10 further comprises an unfiltered photodiode 22, a time multiplexor 24, a signal extractor 26, a flux reference block 28, a comparison block 30, and PID (proportional-integral-derivative) controllers 32a-32c. The overall control system for the LED lighting unit 12 is designated 33.

Upon operation of the LED lighting system 10, the unfiltered photodiode 22 measures the actual (total) flux level of the LED light sources 14a-14c. As such, the unfiltered photodiode 22 cannot distinguish between red, green and blue light. Therefore, in order to individually measure the flux of each LED color, the LED lighting unit's output is measured time sequentially by sequentially switching the different LED colors on/off. Thus, the unfiltered photodiode 22 is time multiplexed over the different LED light sources 14. The actual flux of each color is then determined by the time multiplexor 24 and color signal extractor 26. The actual flux is in the sensor domain.

The actual flux (feedback) is subsequently compared to fixed setpoint values representing a desired flux for each color. These fixed setpoint values are provided by the flux reference block 28, and were determined during calibration at a certain reference temperature. The actual flux and desired flux for each color are compared in the comparison block 30, and the resulting differences are supplied to the PID controllers 32. The PID controllers 32 in turn modify the inputs to the LED drivers 16a-16c in accordance with the derived differences. This adjusts the red, green and blue LED light sources 14a-14c so that the desired flux is output from the LED lighting unit 12 (i.e. the so that the error between the setpoint values and the feedback values reach zero under steady-state conditions). It should be noted that before being passed to the LED lighting unit, the outputs of the PID controllers are converted from the sensor domain to the actuator domain (duty cycles) and multiplied with the outputs from the calibration matrix (i.e. the nominal duty cycles).

FIG. 2 is a block diagram of a LED lighting system according to an embodiment of the present invention. The LED lighting system of FIG. 2 is similar to the LED lighting system 10 of FIG. 1. However, a difference is that two of the intrinsic LED light sources have been replaced by phosphor converted LED light sources, namely the “regular” red LED light source 14a has been replaced with a red phosphor converted LED light source 34a, and the “regular” green LED light source 14b has been replaced with a green phosphor converted LED light source 34b. Here, the phosphor converted LED light sources 34a and 34b comprise blue LEDs covered by wavelength converting phosphor in order to emit red and green light, respectively.

As mentioned above, phosphor converted LEDs are more color stable than regular intrinsic LEDs, but there is also a leakage of unconverted light from the underlying LED. This means that the red phosphor converted LED light source 34a except for red also emits some blue light, while the green phosphor converted LED light source 34b in addition to green also emits some blue light. Since the characteristics of the underlying blue LEDs change with for example temperature during use, the relative amount of red/green and blue light also change during use, which can result in a significant change in color and flux of the output of the LED lighting unit.

If a flux feedback system as disclosed in FIG. 1 was to be used for a LED lighting unit including phosphor converted LED light sources, the flux measurement of the regular blue LED light source would only account for the blue light emitted by the blue LED light source, and not the blue light emitted from the phosphor converted LED light sources (due to leakage). Consequently, the subsequent adjustment of the blue LED light source would not lead to a correct correction with respect to the total blue flux output.

Therefore, according to an embodiment of the invention, the LED lighting system 10 further comprises a blue filtered photodiode 36. The blue filtered photodiode 36 is responsive to the flux of blue light emitted from the LED lighting unit 12. Upon operation, the unfiltered photodiode 22 is time multiplexed over the red and green phosphor converted LED light sources 34a and 34b, as in FIG. 1, in order to determine the actual flux for each of these LED light sources. In order to minimize the influence of the leakage of blue light from each phosphor converted LED light source in this measurement, the unfiltered photodiode 22 preferably has a low sensitivity in the blue spectrum, and higher sensitivity for other wavelengths. The actual flux for the red and green phosphor converted LED light sources 34a and 34b is then used to adjust the corresponding LED light sources, respectively, as in FIG. 1.

Also, the total actual blue flux (i.e. the aggregated actual blue flux for all LED light sources) is measured by the blue filtered photodiode 36 (time integrated measurement), which measurement (first control data) is directly supplied to the comparison block 30 for comparison with a setpoint value representing the desired blue flux. The setpoint value to which the total actual blue flux is compared is supplied by block 28, which calculated the setpoint value based on input from the calibration matrix 20. That is, the reference block 28 converts the nominal duty cycles (in the actuator domain) from the calibration matrix 20 to a blue flux setpoint value (in the sensor domain) at a certain reference temperature. In this way, the total actual blue flux (the leakage from the phosphor converted LED light sources 34a and 34b and the emission from the intrinsic blue LED light source 14c) can continuously be compensated by adjusting the blue LED light source 14c. For example if the blue leakage is increased, this is detected by the system, whereby the intensity of the blue LED light source 14c can be decreased in order to keep the total blue output at a desired level.

Thus, in the embodiment shown in FIG. 2, the output of the blue LED light source is caused to be adjusted by means of the controller 32c in accordance with data provided by the blue filtered photodiode 36 responsive to the blue flux. This greatly increases the flux feedback algorithm's ability to compensate for changes in blue leakage.

FIG. 3 discloses an LED lighting system 10 according to another embodiment of the invention, which system achieves an even more complete compensation for blue leakage. Compared to the system in FIG. 2, the LED lighting system 10 in FIG. 3 comprises an additional time multiplexor 38 coupled to the blue photodiode 36.

Upon operation of the LED lighting system 10 in FIG. 3, the unfiltered photodiode 22 is time multiplexed over the phosphor converted LED light sources 34a and 34b by time multiplexor 24. At the same time, the blue filtered photodiode 36 is time multiplexed over all of the LED light sources 34a, 34b and 14c by time multiplexor 38. The actual blue flux of each phosphor converted LED light source 34a and 34b as well as the actual flux (all colors) for each LED light source are then extracted by the color signal extractor 26.

A suitable scheme for such measurements is shown in table 1. X denotes measurement with the unfiltered photodiode 22, and [X] denotes measurement with the blue filtered photodiode 36.

TABLE 1
Exemplary measurements scheme.

| | Red phosphor | Green phosphor | | |
|---|---|---|---|---|
| | converted LED | converted LED | Blue LED | Back- |
| | light source | light source | light | ground |
| Measurement # | 34a | 34b | source 14c | level |
| 1 | | | | X |
| 2 | | | | [X] |
| 3 | X | | | X |
| 4 | [X] | | | [X] |
| 5 | X | X | | X |
| 6 | [X] | [X] | | [X] |
| 7 | [X] | [X] | [X] | [X] |

As can be seen from table 1, seven measurements are required to obtain the necessary data (compared to four measurements in the systems in FIGS. 1 and 2). The difference between measurements 3 and 1 provides the actual (total) flux for the red phosphor converted LED light source 34a, and the difference between measurements 5 and 3 provides the actual (total) flux for the green phosphor converted LED light source 34b. Similarly, the difference between measurements 4 and 2 provides the actual blue flux for the red phosphor converted LED light source 34a, and the difference between measurements 6 and 4 provides the actual blue flux for the green phosphor converted LED light source 34b. Finally, the difference between measurements 7 and 6 provides the actual blue flux for the blue LED light source 14c. It should be noted that the actual blue flux alternatively could be measured by means of the unfiltered photodiode.

The actual (total) flux for each LED light source is supplied to comparison block 30, for compensation of the output of the LED lighting unit 12. Further, the red and green flux setpoint values in the reference block 28 can now be compensated for blue leakage, which setpoint values were determined during calibration at a certain reference temperature. That is, the setpoint values are re-calculated for the current blue leakage. This re-calculation requires, for each phosphor converted LED light source, the current blue leakage (first control data), the blue leakage at a reference temperature (determined at calibration), and the unfiltered photodiode's sensitivity for the blue and the phosphor converted (in this case red or green) spectrum (known from sensor specifications). The current blue leakage can be calculated using measurements from both the filtered and unfiltered photodiode.

Thus, when the setpoint values representing a desired output of the LED lighting unit 12 are compared to actual flux output for the different LED light sources in the comparison block 30, the setpoint values for red and green are already compensated with respect to blue leakage. Consequently, in the embodiment shown in FIG. 3, the output of the red and green phosphor converted LED light source 34a and 34b is caused to be adjusted by recalculating the corresponding flux setpoint values in reference block 28 in accordance with data provided by the blue filtered photodiode 36 and the unfiltered photodiode 22.

FIG. 4 discloses an LED lighting system 10 according to yet another embodiment of the invention. Compared to the system in FIG. 3, instead of compensating the setpoint values in block 28, the first control data representing the blue leakage of the red and green phosphor converted LED light source 34a and 34b are used to adjust the feedback values for the phosphor converted LED light source 34a and 34b in a block 39, before the feedback values are supplied to the compensation block 30. This also provides for a more robust LED lighting system.

The system of FIG. 3 can be combined with a prior art temperature feed forward system, resulting in a LED lighting system 10 as disclosed in FIG. 5. In FIG. 5, a temperature sensor 40 measures the temperature of a heat sink 42 accommodating the LED light sources 34a, 34b and 14C. The temperature of each LED light source is then calculated in a calculation block 44 by means of the measured heat sink temperature, a thermal model of the system and the electrical current input to the LED light sources. The LED light source temperatures are then used, together with predetermined data showing the relationship between temperature and wavelength, to compensate the duty cycle values of calibration matrix 20 and the setpoint values of flux reference block 28 in order to account/compensate for wavelength shifts as the LEDs change in temperature.

It should be noted that the temperature feed forward system disclosed in FIG. 5 also could be incorporated in the LED lighting system disclosed in FIG. 4.

Finally, it should be noted that the term “flux” as used in this application refers to the light output of a light source, even if the sensitivity of the sensors does not match with the eye sensitivity.

The person skilled in the art realizes that the present invention by no means is limited to the preferred embodiments described above. On the contrary, many modifications and variations are possible within the scope of the appended claims.

1. A light emitting diode (LED) lighting system (10) comprising:
a plurality of LED light sources (14, 34) for generating a mixed color light, said plurality of LED light sources including at least one LED light source (34) comprising at least one LED adapted to emit light of a first wavelength and a wavelength converter for converting at least a portion of the light emitted from the LED(s) to light of another wavelength, and
a control system (33) for individually controlling the flux output of the LED light sources, the control system comprising:
means for providing feedback of the flux of at least one of said LED light sources, said feedback being based on input from an unfiltered sensor (22) responsive to the actual flux of the individual LED light source, for allowing control of the at least one LED light source in accordance with said feedback, and
means for providing first control data based on input from a filtered sensor (36) responsive to the first wavelength flux, for allowing adjustment of at least one LED light source, to compensate for first wavelength leakage of the wavelength converted LED light source(s).

2. A system according to claim 1, wherein
said plurality of LED light sources further includes at least one intrinsic LED light source (14) having a wavelength in the same wavelength range as said first wavelength,
said first control data represents total actual first wavelength flux of all LED light sources, and
said control system is adapted to control said intrinsic LED light source in accordance with a difference between a setpoint value representing a desired flux for the intrinsic LED light source and said first control data.

3. A system according to claim 1, wherein
said means for providing first control data comprises a time multiplexor (38) for time multiplexing the filtered sensor over the wavelength converted LED light source(s),
said first control data represents actual first wavelength flux of each wavelength converted LED light source, and
said control system is adapted to compensate setpoint values representing a desired flux for the wavelength converted LED light source(s) in accordance with said first control data.

4. A system according to claim 1, wherein
said means for providing first control data comprises a time multiplexor (38) for time multiplexing the filtered sensor over wavelength converted the LED light source(s),
said first control data represents actual first wavelength flux of each wavelength converted LED light source, and
said control system is adapted to compensate the feedback for the wavelength converted LED light source(s) in accordance with said first control data.

5. A system according to claim 1, wherein said means for providing feedback comprises a time multiplexor (24) for time multiplexing said unfiltered sensor over LED light sources for which actual total flux is to be obtained.

6. A system according to claim 1, wherein said unfiltered sensor has lower sensitivity for the first wavelength and higher sensitivity for other wavelengths.

7. A system according to claim 1, wherein said sensors are photodiodes.

8. A system according to claim 1, wherein said first wavelength corresponds to blue color.

9. A system according to claim 1, wherein said wavelength converter comprises phosphor.

10. A system according to claim 1, further comprising means (40, 44) for deriving the temperature of each LED light source and means (28) for compensating setpoint values representing desired flux for the LED light sources in accordance with second control data including said LED light source temperatures.

11. A system according to claim 10, wherein said derive means comprises a temperature sensor (40) adapted to measure the temperature of a heat sink (42) accommodating said LED light sources.

12. A system according to claim 11, wherein said derive means further comprises means (44) for calculating the LED light source temperatures based on at least the measured heat sink temperature and a thermal model of the plurality of LED light sources.

13. A control system for a light emitting diode (LED) lighting unit, which LED lighting unit comprises a plurality of LED light sources for generating a mixed color light, said plurality of LED light sources including at least one LED light source comprising at least one LED adapted to emit light of a first wavelength and a wavelength converter for converting at least a portion of the light emitted from said LED(s) to light of another wavelength, wherein the control system is adapted to individually control the flux output of the LED light sources and comprises:
means for providing feedback of the flux of at least one of said LED light sources, said feedback being based on input from an unfiltered sensor responsive to the actual flux of the individual LED light source, for allowing control of the at least one LED light source in accordance with said feedback, and
means for providing first control data based on input from a filtered sensor responsive to the first wavelength flux, for allowing adjustment of at least one LED light source, to compensate for first wavelength leakage of the wavelength converted LED light source(s).

14. A method for controlling a LED lighting unit including a plurality of LED light sources for generating a mixed color light, said plurality of LED light sources including at least one LED light source comprising at least one LED adapted to emit light of a first wavelength and a wavelength converter for converting at least a portion of the light emitted from said LED(s) to light of another wavelength,
the method comprising:
providing feedback of the flux of at least one of said LED light sources, said feedback being based on input from an unfiltered sensor responsive to the actual flux of the individual LED light source,
controlling the at least one LED light source in accordance with said feedback,
providing first control data based on input from a filtered sensor responsive to the first wavelength flux, and
adjusting the flux of at least one LED light source in accordance with said first control data, to compensate for first wavelength leakage of the wavelength converted LED light source(s).
